(19) United States
(12) Patent Application Publication
(10) Pub. No.: US 2008/0070599 A1
(43) Pub. Date: Mar. 20, 2008

(54) Combined cell phone and medical monitoring apparatus

(76) Inventors: Jennifer Apodaca, Albuquerque, NM (US); Patrick Peralta, Albuquerque, NM (US)

Correspondence Address: Alberto A. Leon, Esq., P.O. Box 30684, Albuquerque, NM, 87190, US

(21) Appl. No.: 11/891,488

(22) Filed: Aug. 9, 2007

Related U.S. Application Data
(60) Provisional application No. 60/823,233, filed on Aug. 22, 2006.

(51) Int. Cl. H04Q 7/20

(52) U.S. Cl. 455/458

(57) ABSTRACT

The present invention discloses an apparatus that combines a cellular phone or other wireless device with one or more medical monitoring devices, wherein the two devices share a single housing, power source, display, memory chip and data processor. The apparatus is capable of functioning as a separate medical apparatus and a normal cellular phone and addresses the need for combining multi-function portable medical testing and condition indicator devices into a device that is already carried by the majority of the population. The preferred embodiment of the invention combines a portable device of blood glucose monitoring with a cellular phone and is capable of audibly alerting the user of abnormal test results and storing multiple test results for monitoring and managing chronic conditions. In addition the apparatus is capable of storing and transmitting medical information to healthcare providers or emergency responders if highly abnormal results are obtained.

### CROSS-REFERENCE TO RELATED APPLICATION

I hereby claim the benefit under Title 35, United States Code Section 119(e) of any United States Provisional Application(s) listed below:
Application No; 60/823,233
Filing Date; Aug. 22, 2006

### BACKGROUND OF THE INVENTION

1. Technical Field of the Invention

The present invention relates generally to communication and health indicator monitoring and testing devices. Specifically, the invention relates to a combination communication, medical testing and health indicator monitoring apparatus. More specifically, the present invention enables a user to carry a single, multi-function, portable item as opposed to multiple devices. Although the multiple devices are preferably connected such that an automatic response is communicated, embodiments of the present invention need not necessarily be so interconnected.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention.

2. Description of the Background Art

In the past decade, cellular phones have gone from being an expensive novelty to a standard piece of equipment which the user keeps in its possession or close by at all times. With the rising popularity and shrinking size of cell phones, many companies have begun combining multiple portable devices into a single cellular phone. For instance, many cellular phones now have the additional capabilities of a computer, MP3 player or a PDA. The advent of combining multiple functions into a single device provides convenience to the user and minimizes, and in some cases, eliminates the need to travel with a portable computer.

At the same time as cell phones have become commonplace, many medical devices have become portable. Inexpensive, portable devices for measuring blood pressure, blood glucose and other commonly tested physiological indicators have become staples at pharmacies. Doctors regularly ask patients to obtain and use those portable devices to conduct routine, at home testing and to keep records of the patients' test results for long-term management and monitoring of various conditions.

One recent example of such a portable medical monitoring device is the GlucoWatch®, which was recently approved by the Food and Drug Administration. The GlucoWatch® is a wristwatch-like apparatus designed to continuously monitor blood glucose levels in adults with diabetes. The apparatus is intended to be used with existing monitoring apparatuses that use blood obtained through finger pricks to measure blood glucose. A small electrical current from the apparatus works to extract a tiny amount of fluid through the skin. A thin plastic sensor on the back of the watch measures glucose levels using this fluid—instead of blood—every 20 minutes for 12 hours. The apparatus sounds an alarm if a person's glucose reaches dangerously high or low levels.

The prior art contains several patents for monitoring and transmission of patient data that uses cellular phones, wireless technology, the internet or other forms of communication. For instance, U.S. Pat. No. 7,156,809 to Quy discloses a system which allows monitoring of a patient's test results through the combination of patient medical monitoring with wireless internet transmission.

Some attempts have been made to combine cell phones with medical devices. For example, U.S. Pat. No. 5,772,586 to Heinonen, et al. discloses a method for monitoring a patient's health wherein a monitoring device is stored in the battery compartment of a cell phone and the monitoring device is capable of transmitting data to a health care provider using the cell phone. An important consideration in the utility of such an invention today is how much smaller cell phones and their battery compartments have become in the decade since the patent was issued.

The prior art also discloses cellular phones that have specific capabilities when contacting emergency personnel. For example, U.S. Pat. No. 7,127,229 to Baba, et al discloses an emergency cellular phone with an enhanced GPS positioning method by remote control that gives emergency personnel an exact location of the user when activated during a potential medical emergency.

The present invention addresses the need for combining multiple function, portable medical testing and condition indicator devices into a cellular phone, as well as using the memory in a cellular phone to store important medical information that is available to the patient and medical personnel by pushing a designated button on the keypad. The combination of this invention gives the medical testing and condition indicator devices all the benefits of a cellular phone, such as Code Division Multiple Access (“CDMA”) or Global System for Mobile Communication (“GSM”) cell phone operation, automatic physical location through a GPS system, and the ability to store, retrieve and transmit important information, such as allergies, medical history, test results and current medications. The combination device of this invention is ideally suited for marshalling health indicators which are crucial in the monitoring, management and treatment of chronic illnesses like diabetes.

Diabetes is a group of chronic diseases characterized by the body's inability to produce or properly use insulin, a hormone that helps maintain normal levels of sugar (glucose) in the blood. The body needs insulin to convert sugar, starches and other food into energy. The hormone acts as a key that unlocks cells to allow glucose to enter. In diabetes, glucose that cannot be utilized builds up in the blood.

There is no known cure for diabetes, and blood glucose monitoring is a key component in diabetes treatment and management. Consistently high blood sugar levels can, over time, lead to health complications such as blindness, kidney disease, heart disease, and nerve damage.

Diabetes is a leading cause of death in the United States and complications linked to poor control of blood glucose levels result in nearly $100 billion in medical costs annually, according to the National Institute of Diabetes and Digestive and Kidney Diseases.

People with Type 1 diabetes, whose pancreases no longer produce insulin, must inject insulin to control the levels of glucose in the blood. Frequent tests (several times a day) using blood obtained from finger pricks are required to maintain good blood sugar control and hence good diabetes management. Patients with Type 2 diabetes, whose pancreases do not make enough insulin or whose bodies don not use insulin properly, often control their diabetes through medication, exercise, diet, and sometimes insulin injections. The latter patients also must test their glucose levels to ensure good blood sugar control. An estimated 90 percent to 95 percent of the 16 million people in the United States with diabetes have Type 2, which generally develops after age 40. A substantial percentage of patients who have to test their blood levels, including many children, usually need to stop what they are doing and take other affirmative steps to perform the test and read the results. Often, the patient then needs to take a medication to control or manage the condition indicated by the test.

### SUMMARY OF THE INVENTION

The present application discloses and claims a medical monitoring and testing device capable of sensing one or more physiological indicators by allowing the patient to conduct a test and observe the results, and of wirelessly communicating the results or a number of emergency conditions to the patient's doctor or to medical health personnel. The device of this invention is also capable of providing warnings to the patient in relation to upcoming necessary tests or medication which the patient needs to take, testing for a particular physiological indicator and providing an accurate result. In addition, the cellular phone of this invention is capable of storing medical information about the user that can be accessed by pushing a specialized and easily recognizable button on the keypad.

The term “cell phone” as used throughout this application is intended to include any and all portable wireless communication devices.

The apparatus of the present invention combines a cell phone with one or more medical monitoring and testing apparatuses. The apparatus preferably functions as a normal cell phone and as a separate medical apparatus that shares a common housing, battery, display, processor, and/or memory chip. The term “memory” as used throughout this application means all forms of computer memory, excluding memory requiring electromechanical read systems.

If the medical apparatus requires any processing or computation for it to function, design and manufacturing costs can be reduced by having the cell phone apparatus and the medical monitoring apparatus share one processor. In addition, a Global Positioning System (“GPS”) capability is optionally included so that if a medical emergency occurs, help can be summoned with the user's location automatically indicated and transmitted to a predetermined recipient, such as emergency personnel. Furthermore, because cell phones often contain a substantial amount of memory, the present invention can store pertinent medical information that is readily available to the user or a medical service provider, preferably by pushing a single button on the keypad set aside for the purpose of accessing that information. Such a specialized button can be marked with a red cross or may be solid red in color so that its function is readily apparent.

Some benefits of the present invention preferably include its small pocket size; Code Division Multiple Access (“CDMA”) or Global System for Mobile Communication (“GSM”) cell phone operation; blood sugar or other medical monitoring apparatus; storage and one-touch retrieval of medical information, e.g. allergies, medical history and current medications; and automatic physical location through a GPS system in an emergency.

A benefit of the present invention is that several apparatuses can perform very different functions while operating together and sharing housing, power sources and other resources. One of those resources is preferably computational memory. As mentioned, cell phone chip sets now typically have substantial memory. For example, the Motorola Q® phone boasts 64 MB of memory. Additionally, it has over 200 hours of standby power in its rechargeable lithium ion battery. That battery, for example, can easily be shared by a blood monitoring apparatus which is typically used only a few times a day.

One of the main benefits of the present invention, which distinguishes it from the devices of the prior art, stems from the fact that so many of the required functions of the present invention have been addressed individually and independently. The phone and location circuitry have been reduced as mass produced chip sets. Those components integrate a large number of functions into a single cell phone apparatus that is primarily aimed at entertainment and communications. In one embodiment of the present invention, a medical apparatus is preferably substituted for or added to an entertainment portion of a phone.

Some of the non-invasive blood-sugar monitoring methods, systems, and apparatuses that are optionally incorporated into the present invention include but are not limited to:

1) shining a beam of light onto the skin or through body tissues;

2) measuring the energy waves (infrared radiation) emitted by the body;

3) applying radio waves to the fingertips;

4) using ultrasound; and

5) checking the viscosity of fluids in tissue underneath the skin.

### DETAILED DESCRIPTION OF THE PREFERRED EMBODIMENT OF THE INVENTION

The preferred embodiment of the present invention is directed to testing, monitoring diabetes indicators, and to storing, organizing, retrieving and transmitting test result and other medical data. Glucose level monitoring can be accomplished using a blood sample obtained by the conventional method or can be determined by any other method or apparatus known to monitor blood sugar levels. The diabetes monitor of the present invention preferably measures blood sugar. However, the medical monitoring apparatus can be for virtually any disease or condition for which a portable monitoring device is available, and the present invention is thus not limited to diabetes or the detection or monitoring of blood sugar.

The overall block diagram of the preferred embodiment of the present invention is illustrated in FIG. 1. As indicated, several of the blocks are available as integrated assemblies. Higher levels of integration are constantly being offered as exemplified by the availability of third generation (3G) phones. The apparatus comprises the cell phone portion, the blood sugar monitor portion and a rigid housing. The cell phone portion and the blood sugar monitoring portion are securely fastened within the housing.

As illustrated in FIG. 1, the center of the apparatus is a cell phone portion, which comprises a baseband module, a radio module, a power amplifier module, a power management module, a rechargeable battery, a display, a keypad, an antenna, a filter diplexer and a GPS receiver chip. The baseband module comprising a baseband chip set, an audio module, and a radio to baseband interface, the audio module comprising a microphone and a speaker. The elements of the cell phone portion are fixedly attached to the rigid housing.

The baseband chip set comprises a data processing means and a data storage means. The data processing means is capable of processing data, extracting voice data from the microwave carrier, putting the outgoing voice on the carrier (modulation), controlling what data goes in and out of memory, taking in all commands, and/or outputting information to the display. The data processing means comprises a baseband processor and host controller. The keypad allows the user to interact with the data processing means. The central part of the baseband chip set portion, which is preferably multi-functionally shared, is the data storage means. The data storage means is operatively connected to the data processing means. The data storage means comprises random access memory (“RAM”) and flash memory. The flash memory retains its contents when the unit is turned off and can be rewritten hundreds of thousands of times. With memory chips extremely compact, an almost microscopic chip can store millions of bits of data. In an embodiment of the present invention, the memory preferably stores the startup procedure for the cell phone, last location from the GPS data, phone numbers, readings from the blood sugar monitor with time tags, the owner's medical history, and other critical or pertinent information. The baseband portion further comprises the radio to baseband interface and the audio chip, which is operatively connected to a microphone and a speaker. Additionally, a GPS receiver chip is operatively connected to the data processing means and the filter diplexer. The data processing means is operatively connected, directly or indirectly, to every component of the apparatus.

The user can control the functions of the cell phone and the medical apparatus through the cellular phone's keypad, which is operatively connected to the data processing means. The key pad is combined with a printed circuit board having terminals corresponding to the buttons. The circuit board is interfaced with the data processing means. In the preferred embodiment, a standard cell phone keypad is not used. Rather, the keypad of the apparatus preferably comprises additional buttons with functions related to the medical apparatus. The additional medical button specifically accesses medical information stored in the data storage of the phone. Preferably activating the button would bring up a menu on the display with categories of stored information, such as medical history, allergies, current medications, conditions and treatments and test results. The medical button is red or is marked with a red cross in the preferred embodiment of the invention so that it is easily recognizable to caregivers in an emergency. One or more additional buttons, the monitoring buttons, turn on and control the medical apparatus, which in the preferred embodiment is a blood sugar monitor. In an alternative embodiment, the standard keypad can be used to access a menu of functions to control the medical apparatus.

The rechargeable battery in the preferred embodiment is a lithium-polymer battery, which has a low weight and can be shaped differently from traditional rectangular cell phone batteries to create space for the medical monitoring apparatus. In alternative embodiments, the battery can be lithium-ion or nickel metal-hydride.

Having performed all these functions, the baseband module preferably outputs an audio signal to the radio module to modulate a carrier. That carrier is amplified in the power amplifier module and sent to the antenna for transmission. The antenna is preferably connected to the system via a filter diplexer. The purpose of the diplexer is to separate the received signals. One received signal is preferably the cell phone signal which comprises incoming communications. The other signal is preferably a signal GPS. This signal is preferably processed in a GPS receiver chip that calculates the position of the unit on Earth. That information is then preferably stored in the data storage means and frequently updated. The calculated result is then preferably transmitted along with the audio modulated carrier so that the cell phone company and any emergency responding authority can decode the signal and determine where the call is originating.

The blood sugar monitor portion is also preferably constructed as a chip set and an electro mechanical/chemical apparatus or an electronic apparatus, but preferably functions separately from the cell phone portion of the present invention. The blood sugar monitor portion preferably comprises a sample collector. The sample can be collected with a conventional finger prick and sample absorber or by another technique. The blood or fluid sample is analyzed by light or electrical spectroscopy. In the preferred embodiment, the cell phone's baseband processor is used to control this operation, calculate the test result and then place the output data in the cell phone's memory. The results of this test, along with recent history of the last few tests, are then sent to the cell phone's display for the user interface. Initiation of the test is signaled though the phone keypad which has one or more additional keys dedicated to the blood glucose monitor or other medical apparatus in the preferred embodiment. This information is preferably recorded in the unit's memory along with a time tag. An accurate time tag is obtained from various sources. One optional source is the GPS, which derives its time from an atomic standard. Another optional source is the cell tower. The number of tests to be stored and retained is determined during the detailed design, but is preferably comparable with the numbers found for the apparatuses listed in the Blood Glucose Meter Table of FIG. 2. This information is preferably made available to medical personnel providing treatment to the patient along with the long term history stored in the apparatus of the present invention. The information is easily retrieved by pressing a specialized medical button on the keypad set aside for accessing medical data.

For the most part, the apparatus of the present invention preferably functions as a normal cell phone and as a separate medical apparatus that share a common housing, battery, display, processor, and/or memory. However, if the medical readings are abnormal, the present invention optionally audibly alerts the user through the speaker with a warning tone. If the results of a test are extremely abnormal, the phone optionally sounds an alert or initiates another corroborative test that requires a response from the patient. If the patient does not respond or does not satisfactorily complete the test, the processor assumes that the patient is incapacitated and optionally automatically calls for help. During that call, the location of the patient is preferably transmitted to a predetermined recipient along with the stored medical history. For diabetes patients this is expected to be a rare occurrence.

Another embodiment of the present invention preferably comprises a blood pressure medical monitoring apparatus and a cell phone apparatus.

In yet another embodiment of the present invention, the cell phone apparatus preferably comprises an electrical port to which one or more medical monitoring devices can be removably connected.

The invention disclosed and claimed herein is not limited to the exact details detailed in the specification and shown in the figures, since equivalents and colorable imitations thereof will be evident to a person of ordinary skill in the art. Thus, the invention may be practiced otherwise than as specifically shown, described and claimed herein.

Although the invention has been described in detail with particular reference to the preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a block diagram which illustrates an embodiment of the present invention;

FIG. 2 is a table which illustrates some of the glucose meters which can optimally be modified to combine or communicate with the cell phone of the present invention.

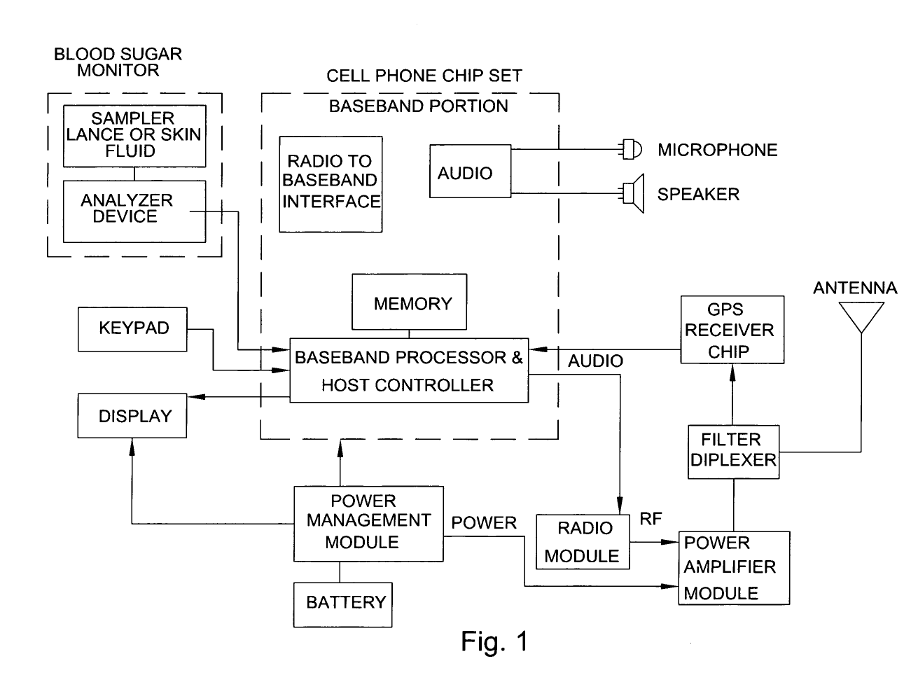

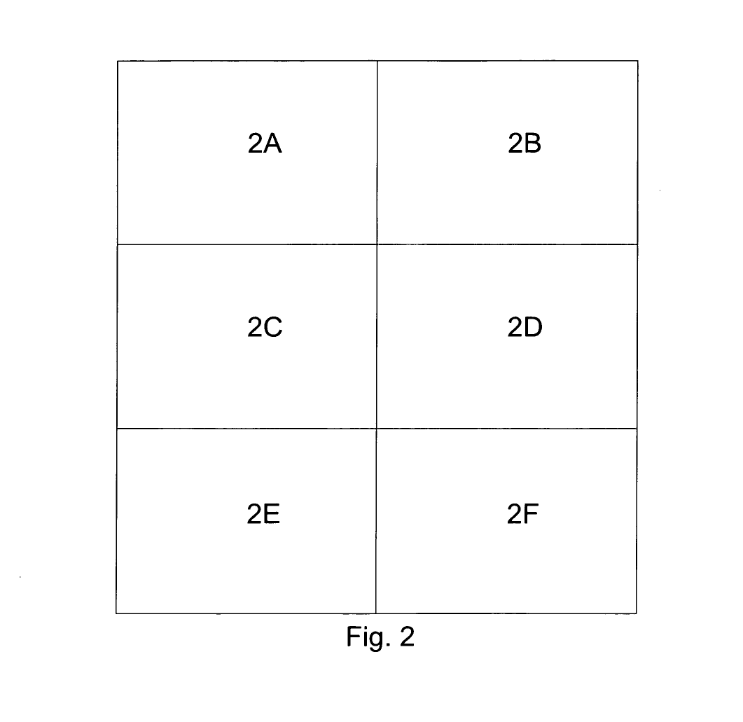

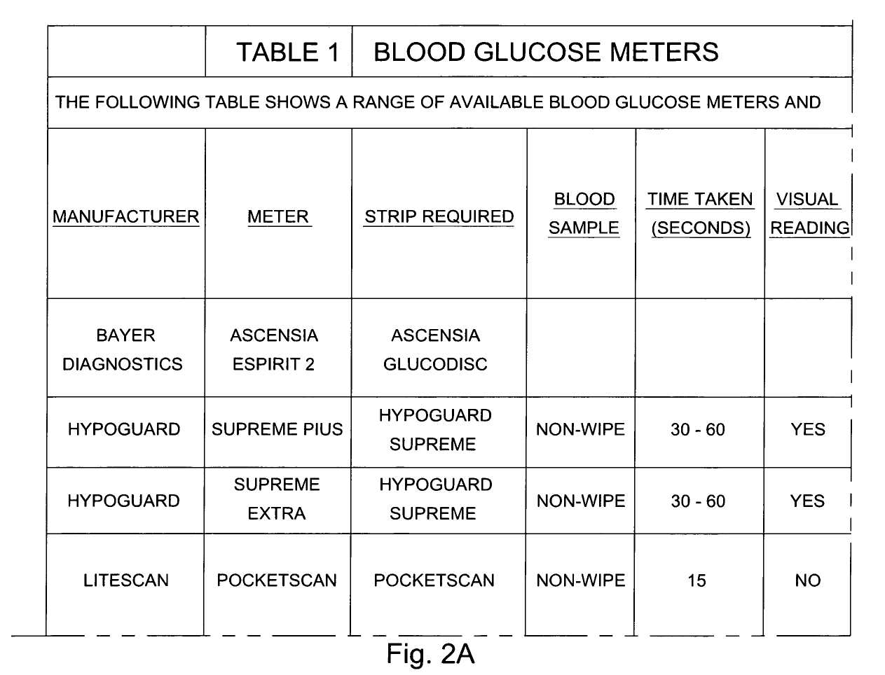

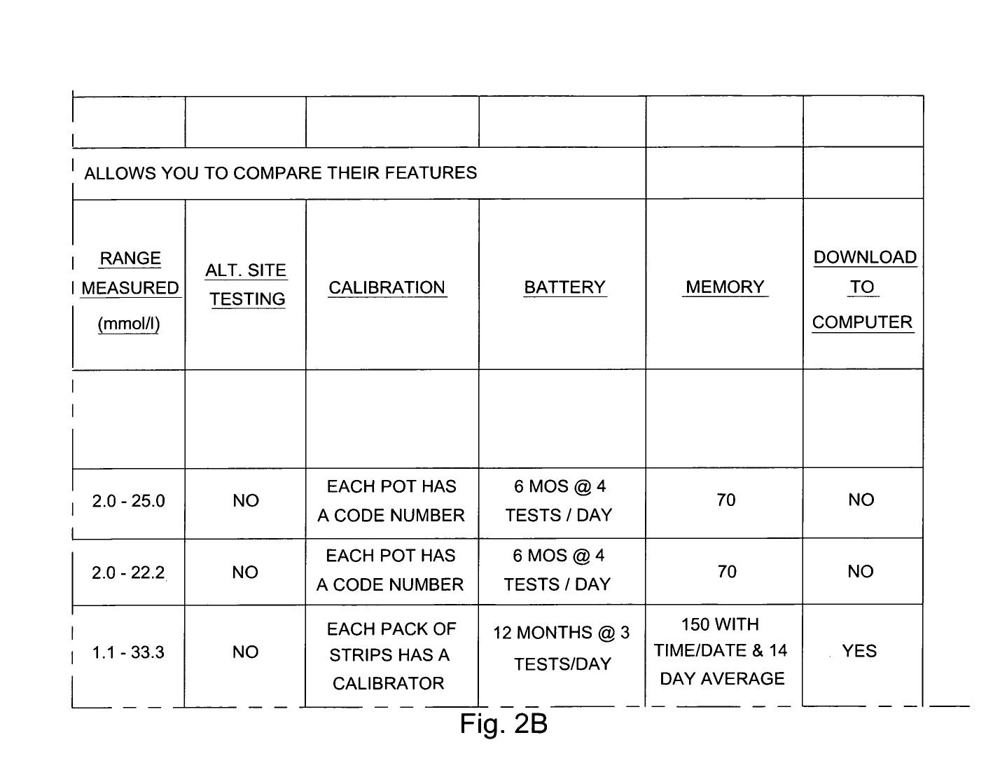

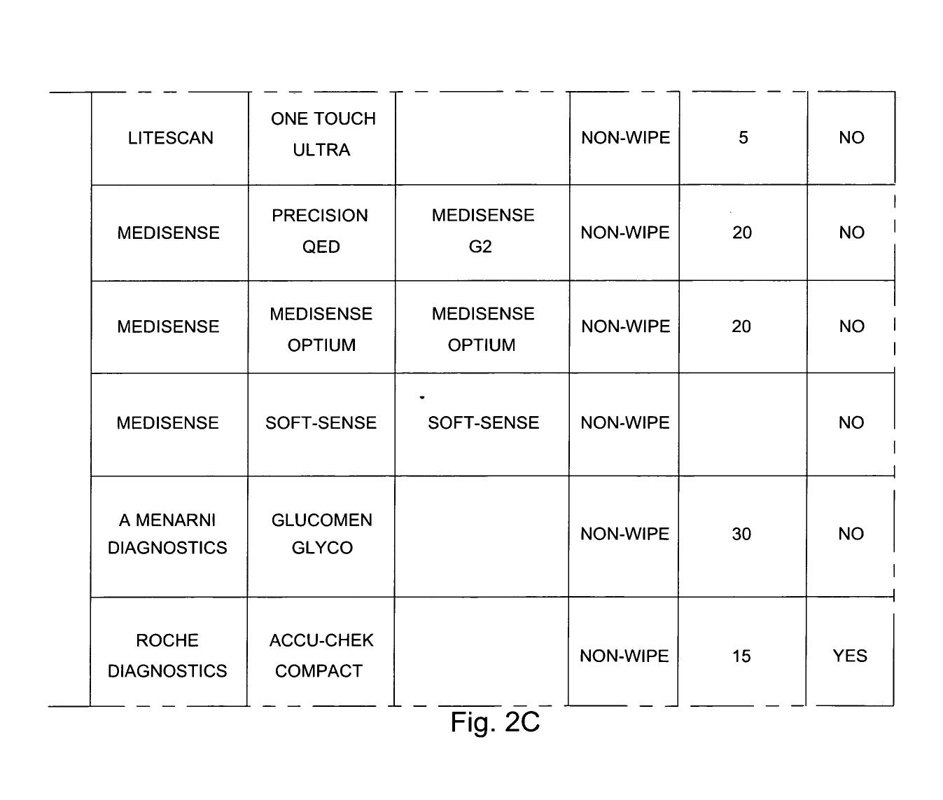

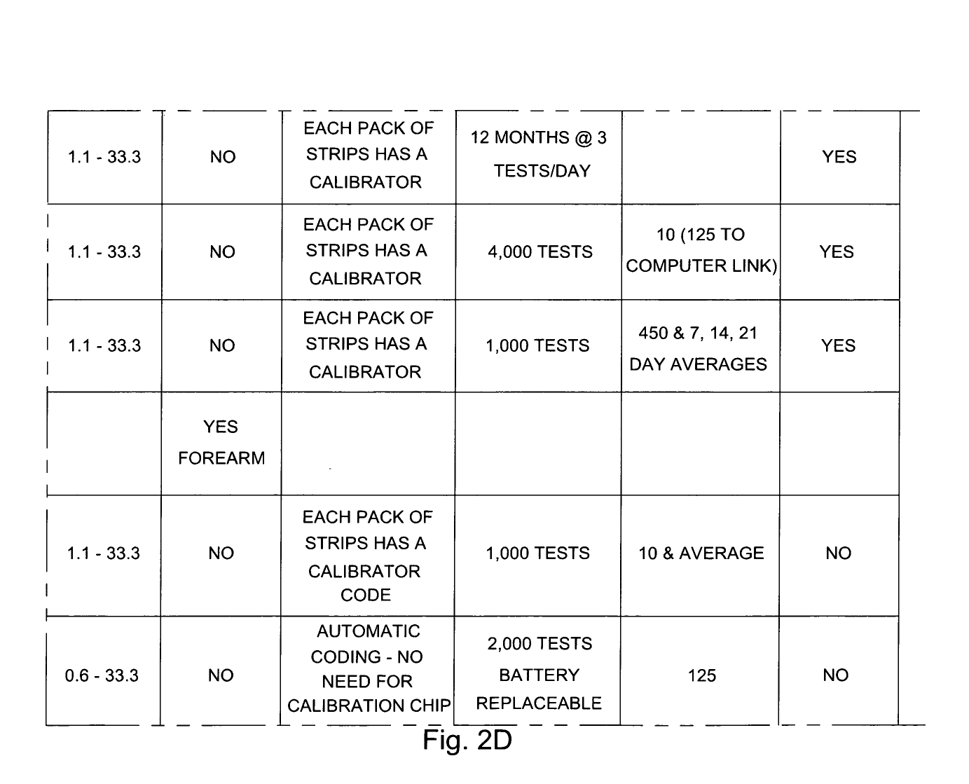

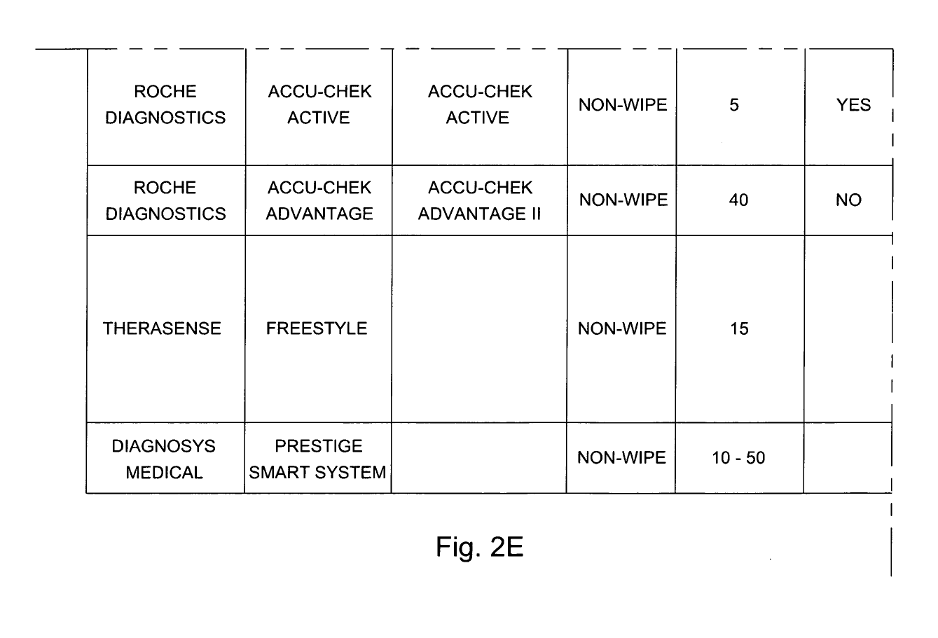

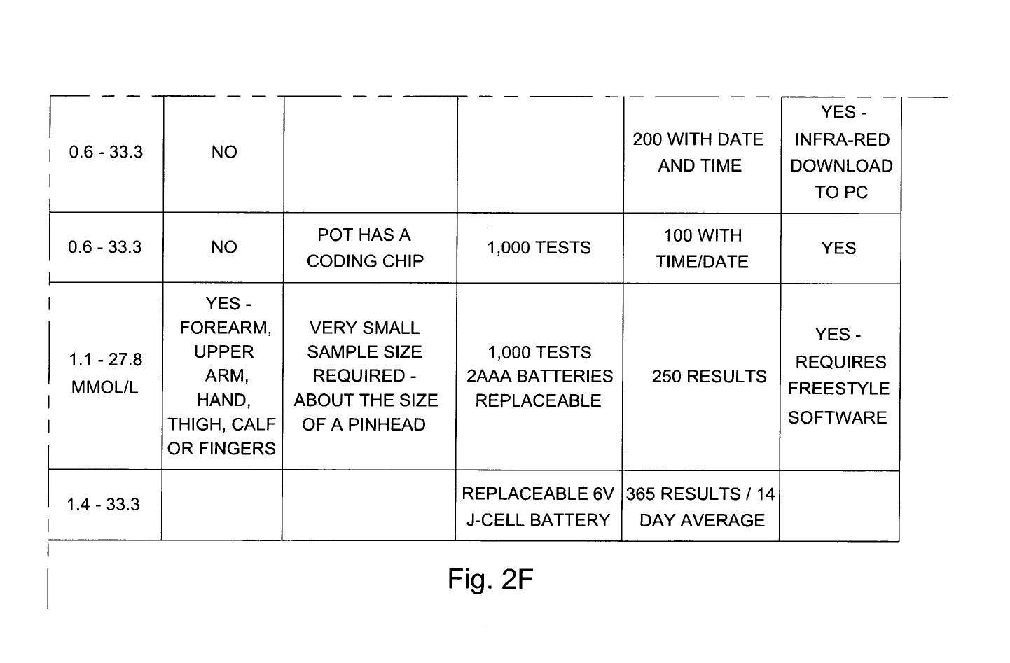

What is claimed is:

1. A combination wireless telephonic transmission, medical monitoring and testing apparatus comprising:
a. a rigid housing;
b. a cellular phone portion, securely fastened to the rigid housing, the cellular phone portion comprising:
i. a baseband module, the baseband module comprising a baseband chip set, an audio module, and a radio to baseband interface, the audio module comprising a microphone and a speaker, the baseband chip set comprising a data processing means and a data storage means, the data processing means comprising a baseband processor and a host controller and being capable of processing data, extracting voice data from a microwave carrier, modulating an outgoing voice on a carrier, controlling what goes in and out of memory, taking in all commands, and outputting information to a display, the data storing means comprising one or more memory chips comprising both random access memory and flash memory, the flash memory being capable of retaining its contents when the unit is turned and storing the startup procedure for the cell phone, last location from the global positioning system data, phone numbers, and multiple medical test results with time tags,
ii. a power amplifier module capable of amplifying a carrier signal,
iii. a power management module,
iv. a rechargeable battery operatively connected to the power management module,
v. a radio module operatively connected to the data processing means, the radio module being capable receiving an audio signal from the baseband module, modulating a carrier signal and outputting a carrier signal to the power amplifier module for amplification,
vi. a display operatively connected to the power management module and the data processing means,
vii. a keypad operatively connected to the data processing means,
viii. an antenna,
ix. a filter diplexer operatively connected to the antenna, the filter diplexer being capable of separating received cellular phone and global positioning system signals and receiving carrier signals from the power amplifier module for transmission by the antenna, and
x. a global positioning system receiver chip operatively connected to the filter diplexer and the data processing means, the chip being capable of calculating the position of the apparatus on Earth using a global positioning system signal isolated by the filter diplexer and sending the unit's positioning data for storage in the flash memory; and
c. one or more medical monitoring apparatuses capable of sensing one or more physiological indicators of a user by performing and interpreting medical tests, the medical monitoring apparatus being securely fastened to the rigid housing, the medical monitoring apparatus comprising a sample collector and an analyzer chip set, the analyzer chip set being operatively connected to the data processing means of the cellular phone portion.

2. A combination wireless telephonic transmission, medical monitoring and testing device housed together according to claim 1, wherein the battery is a selected from a group consisting of: a lithium ion battery, a lithium polymer battery, and a nickel metal-hydride battery.

3. A combination wireless telephonic transmission, medical monitoring and testing device housed together according to claim 1, wherein the keypad comprises one or more keys capable of controlling the medical monitoring apparatus.

4. A combination wireless telephonic transmission, medical monitoring and testing device housed together according to claim 1, wherein the keypad comprises one key capable of directly accessing medical information stored in the data storage means and causing it to appear on the display.

5. A combination wireless telephonic transmission, medical monitoring and testing device housed together according to claim 1, wherein the cell phone apparatus comprises an electrical port to which one or more medical apparatuses can be removably connected.

6. A combination wireless telephonic transmission, medical monitoring and testing device housed together according to claim 1, wherein an audible alert sounds through the speaker when abnormal test results are obtained by the medical monitoring apparatus.

7. A combination wireless telephonic transmission, medical monitoring and testing device housed together according to claim 1, wherein medical monitoring data is automatically transmitted by the cellular phone portion to a pre-determined location at regular intervals or upon one or more abnormal test results.

8. A combination wireless telephonic transmission, medical monitoring and testing device housed together according to claim 1, wherein the medical monitoring device measures blood glucose through a method selected from a group consisting of: shining a beam of light onto the skin, shining a beam of light through body tissues, measuring the infrared radiation emitted by the body, applying radio waves to the fingertips, using ultrasound and checking the viscosity of fluids in tissue underneath the skin.

9. A combination wireless telephonic transmission, medical monitoring and testing device housed together according to claim 1, wherein the medical monitoring device measures blood pressure.
